(19) United States
(12) Patent Application Publication
(10) Pub. No.: US 2023/0067063 A1
(43) Pub. Date: Mar. 2, 2023

(54) SYSTEMS AND METHODS FOR SHARING BETTING INFORMATION

(71) Applicant: Taild Sports, Inc., San Francisco, CA (US)

(72) Inventors: Edward Mauze, San Francisco, CA (US); William Thomas Coomber, Mill Valley, CA (US); Parker Gilmour Walls, Mill Valley, CA (US)

(73) Assignee: Taild Sports, Inc., San Francisco, CA (US)

(21) Appl. No.: 17/893,021

(22) Filed: Aug. 22, 2022

Related U.S. Application Data
(60) Provisional application No. 63/324,730, filed on Mar. 29, 2022.
(60) Provisional application No. 63/236,585, filed on Aug. 24, 2021.

(51) Int. Cl. G07F 17/32

(52) U.S. Cl. CPC G07F 17/323; G07F 17/3204

(57) ABSTRACT

The present invention relates to a system and method for collaborating among a plurality of users wherein a first user's bet information is received and displayed at a device for a second user, the first user's bet information including identifying information (e.g., the teams participating in an athletic competition) for a bet that was made or suggested by the first user and a control is displayed permitting the second user to select to tail the bet that was made or suggested by the first user. In one aspect of the invention, one or more bids from corresponding one or more sportsbooks for the bet selected by the second user are received and displayed at the second user's device, the bids including odds for the selected bet. Optionally, a leaderboard listing one or more of the users having the best betting performance is received and displayed at the second user's device.

### RELATED APPLICATIONS

This application is a Non-Provisional of Provisional (35 USC 119(e)) of U.S. Application Ser. No. 63/324,730, filed Mar. 29, 2022, entitled “SYSTEMS AND METHODS FOR SHARING BETTING INFORMATION”. This application is a Non-Provisional of Provisional (35 USC 119(e)) of U.S. Application Ser. No. 63/236,585, filed Aug. 24, 2021, entitled “SYSTEMS AND METHODS FOR SHARING BETTING INFORMATION”. The entire contents of these applications are incorporated herein by reference in their entirety.

### BACKGROUND OF THE INVENTION

It is appreciated that conventional methods and applications for sharing sports betting information are lacking. In particular, since wagering on college and professional sports has been legalized, there have been a plethora of software applications for booking sports bets online such as those provided by sports book systems, such as, for instance, FanDuel, DraftKings, Pointset, among others. Typically, such systems provide their own individualized software application through which users may place bets. In addition, it is appreciated that there are many different sources for live sports statistics and other information relating to sporting events upon which bets are placed, such as ESPN, CBSSports, among others.

It is also appreciated that sports betting is a social event that allows users to discuss bets, games, and their favorite teams. Unfortunately, conventional applications do not have the collection of information and features that permit a true social experience among groups of users. Accordingly, there exists a need for a system that allows groups of users to communication and collaborate about their bettings.

### SUMMARY OF THE INVENTION

In some aspects described herein, a messaging application is provided that permits users to communicate within groups for the purpose of placing bets with sports betting systems. In some embodiments, users are permitted to see other users' bets, “tail” them, and/or otherwise communicate in real time for the purpose of enjoying betting activities in a social experience. Further, because conventionally there are multiple applications that would be needed to effectively communicate in a group setting, a single messaging application is provided that converges real-time sporting event information with messaging and that information relating to individuals' bets that are placed with one or more sports betting operations (e.g., a sportsbook).

In some embodiments, a messaging application includes controls and functionality that reduce the number of user actions necessary to share and communicate sports betting information. For instance, in some embodiments a user may “text” or otherwise send a message to other users including bet information. The bet information may be, in some embodiments, actionable information such that a receiving user may easily re-create the bet for themselves (e.g., within their own sportsbook account) from an action performed within the messaging interface. For instance, this may be accomplished using deep links that when selected, perform an action within that user's sportsbook account (e.g., creates an identical bet in FanDuel Betslip). In this way, users are permitted to easily “tail” friend's bets through a social interface.

In other implementations, the system may perform other functions, such as for example, receiving live sports information from a variety of sources and presenting it to the user within the consolidated interface. The application may also serve as a focal point for all of the user's bets from a number of third-party betting organizations such that each of the bets may be more easily tracked. Further, the system may track a user's betting performance over a number of sports book operations and the system may have the capability of comparing the user's betting performance to other users (e.g., such as the user's friends within a defined group).

In some implementations, the messaging interface may include a user interface element that tracks all of the bets made by the user, and in some embodiments, the user interface element presents all of the bets made by the user within a particular user group (e.g., the user's friends). In this way, the user may access real-time information about bets placed by other members of the group, may be permitted to play similar bets, and/or may otherwise communicate with the group regarding the bets.

In some embodiments, the system may be integrated with one or more various sportsbooks to permit the synchronization of betting information among a group of users. Such information may be communicated within the application itself (e.g., within a “banner” element that shows all of the bets placed by users of the group) or particular users may be permitted to communicate bets to one or more users within a messaging motif.

In some embodiments described herein, a messaging interface is provided that permits users to communicate that information. In some embodiments, the system is configured to automatically send that information to members of a group. Further the system may be configured to integrate with one or more third-party betting sources such as a sportsbook. This may be accomplished, for example, through one or more APIs that are configured to create bets in such systems.

In some embodiments, the system comprises a messaging application that receives betting information and stores bets from a number of sources within a profile for a particular user (e.g., in a cloud-based management system). In this way, the user is permitted to track all of their bets over a number of sources. Further, the messaging interface may include capabilities for sending that information to other users within the interface. In some embodiments, bet information for a particular user is displayed in a carousel or banner-like UI element, where each of the user's bets are displayed to the user in a rotating fashion. The banner may also include bets placed by other members of a group to which the user belongs.

In some embodiments, the messaging interface provides the capability for “tailing” another user's bets in a more efficient way. To this end, the system might include a control that takes the key parameters from a particular viewed bet (e.g., from another user) and when selected, places that bet with third party sportsbook using a reduced number of interface actions. In some embodiments, when users from particular group place bets, these bets are displayed to other users within the group, and these displayed bets are actionable by all members of the group. In this way, the betting activities become more socially engaged and as a result the number of bets that are placed in third-party sportsbooks are increased among the group.

In some aspects, a system is provided comprising a messaging interface comprising a plurality of display elements, the plurality of display elements including at least one of the plurality of display elements configured to display bet information of a first user. In some embodiments, the at least one of the display elements is configured to display bet information relating to members of a group to which the first user belongs. In some embodiments, the system further comprises an interface configured to receive bet information for the first user from one or more third party sources.

In some embodiments, the system further comprises means for storing a profile for the first user and means for requesting the bet information for the first user from the one or more third party sources and means for associating the bet information with the profile. In some embodiments, the messaging interface is adapted to send, from the first user, bet information relating to a third-party betting platform to a second user. In some embodiments, the at least one of the plurality of display elements is configured to display, within a banner section of the messaging interface, the received bet information for the first user from the one or more third party sources.

In some embodiments, the messaging interface includes at least one of a group comprising Facebook messenger, WhatsApp, Kik, WeChat, Twitter, or any person-to-person or person-group messaging interface. In some embodiments, the messaging interface is configured to permit the first user to view bet information of a second user, and wherein the messaging interface includes a control that permits the first user to perform a tail bet on a bet defined within the viewed bet information of the second user.

In some embodiments, the system further comprises a statistics component that is configured to analyze betting performance of the first user based on, at least in part, the received bet information for the first user from one or more third party sources. In some embodiments, the messaging interface is configured to display within at least a portion of the interface, live score information received from one or more third party sources. In some embodiments, the at least one of the plurality of display elements is configured to display, within a banner section of the messaging interface, bet information relating to members of a group to which the first user belongs. In some embodiments, the messaging interface is adapted to send, from the first user, bet information relating to members of a group to which the first user belongs.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence is intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of a distributed computer system 100 capable of communicating bet information among one or more users;

FIG. 2 shows an example process for communicating bet information for a user;

FIG. 3 shows an example process for creating a new bet for a group user based on communicated bet information of a user;

FIG. 4 shows an example process for messaging bet information between users;

FIG. 5 shows an example process for receiving third party sports information for activities related to bet information for a user;

FIG. 6 shows an example process for tailing a bet of another user;

FIG. 7 shows an example interface for a messaging application that is configured to communicate bet information;

FIGS. 8 and 9 show various alternative interfaces for communicating bet information among users within a messaging application.

FIG. 10 shows additional information that may be shared among the users in a group on a user's messaging interface on a mobile device 700.

FIG. 11 shows additional information that may be shared among the users in a group on a user's messaging interface 701 on a mobile device 700.

FIG. 12 shows information that may be displayed on a user's messaging interface 701 on a mobile device 700 about community discussion channels.

FIG. 13 shows how a user may “tail” or duplicate one or more bets (e.g., an individual bet, a synced bet, a parlay) made by another user.

FIG. 14 shows information relating to pinned user's bets that may be displayed on a user's board 1401 on a messaging interface 701 on a mobile device 700.

FIG. 15 shows activity feeds 1501 and/or profiles 1504 for users such as celebrities and/or well-known gamblers that may appear on a message board on a messaging interface 701 on a mobile device 700.

FIG. 16 illustrates an exemplary user profile 1601 displayed on a messaging interface 701 on a user's mobile device 700.

FIG. 17 illustrates users receiving messages about bets made by other users and how users have the option to instantly tail the bets.

FIG. 18 illustrates the steps that may be performed for one user to “tail” a bet suggested or made by another user in one embodiment of the invention.

FIG. 19 illustrates the steps that may be performed for a first user to “tail’ a bet made by a second user and to have the option of selecting a sportsbook partner to make the bet, rather than being forced to make the bet at the same sportsbook partner where the second user previously made the bet.

FIG. 20 illustrates an exemplary bet auction platform.

FIG. 21 illustrates live audio rooms in which users in a group may speak to one another.

FIG. 22 illustrates a feed of the suggested and/or made bets by one or more friends of a user.

FIG. 23 illustrates a leaderboard showing the betters who are the most tailed, as illustrated by FIG. 23.

### DETAILED DESCRIPTION OF INVENTION

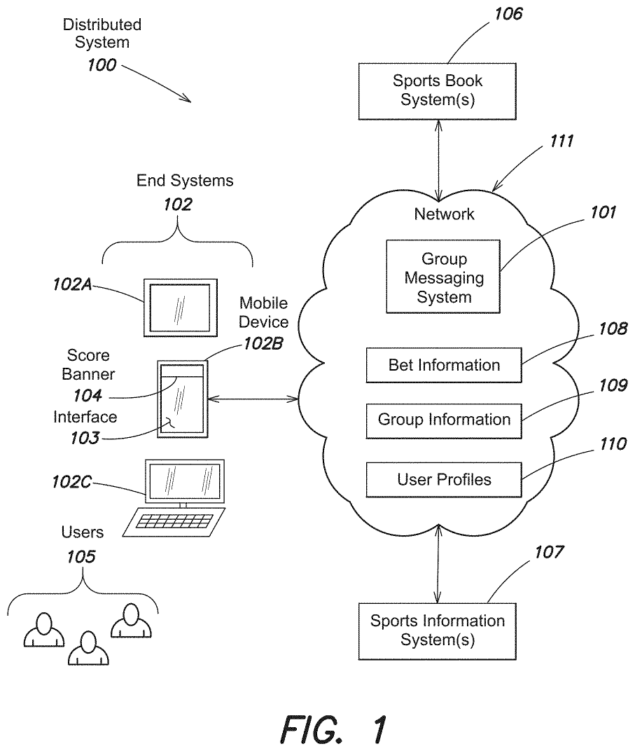

FIG. 1 shows a block diagram of a distributed computer system 100 capable of communicating bet information among one or more users. In particular, distributed system includes one or more end systems 102 through which users (e.g., users 105) communicate bet information (e.g., for example, users may operate one or more end systems types such as, for example, a tablet (e.g., element 102A), a mobile device (e.g., element 102B), a laptop (e.g., element 102C) or other computing device. Each end system includes an interface (e.g., interface 103) through which users interact with other users and share that information. Interface 103 may have one or more areas, controls, or screens that permit users to view scores, review bet information, interact and copy bets, and otherwise communicate within a messaging application to other users.

Users may communicate with each other over one or more communication networks (e.g., network 111) within a cloud-based messaging application. To this end, a group messaging system 101 is provided that performs a number of functions including integrating with one or more sports book systems (e.g., element 106), transmitting messages between users, storing and maintaining bet information received from one or more third party sources, maintaining information related to groups of users (e.g., group information 109), maintaining user profiles (e.g. user profiles 110), among other functions. Further, distributed system 100 may be integrated with one or more sports information systems (e.g., systems 107) for the purpose of receiving real-time information relating to the sports events upon which users place bets.

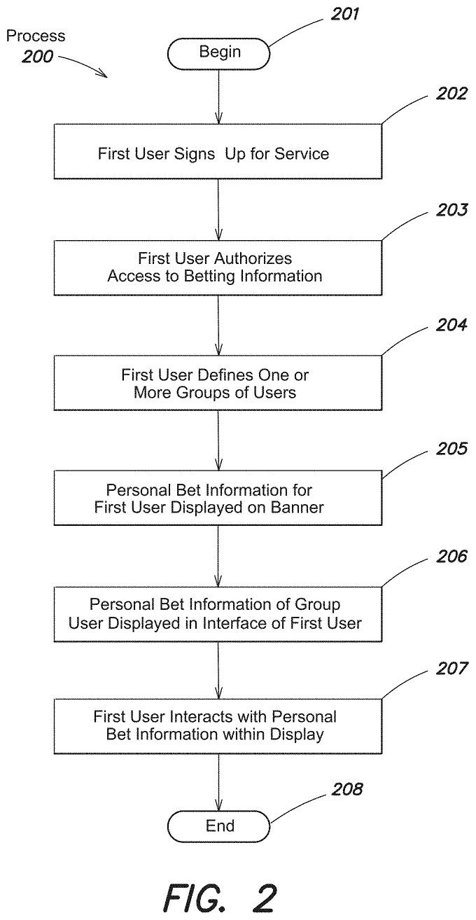

FIG. 2 shows an example process 200 for communicating bet information for a first user. For example, the process may be performed using one or more computing elements discussed above with respect to FIG. 1. At block 201, process 200 begins. At block 202, a first user signs up for the service. For example, the user may provide a username and password for access to the group messaging system functions. In some embodiments, the system performs third-party integration with one or more sports book systems. To this end, the system may permit the user to receive all of the sports bets that were placed within these third-party systems and track them within a single application. At block 203, the first user may authorize access to their betting information that resides on these third-party systems.

At block 204, the first user defines one or more groups of users to which they will communicate. For instance, the user may be permitted to define a friends group that allows the users with that group to freely share betting information among each other.

Because the system is capable of storing betting information for a particular user, that user's bet information may be displayed in one or more locations within the application used by that user. For instance, all of the personal bets which are placed by a first user may be displayed within a banner, which may be rotatably displayed to the first user within that user's mobile device application (e.g., at block 205). Furthermore, the banner or other location may be used to display bet information for other users (e.g., a group user) within the mobile device interface of the first user (e.g., at block 206). That is, the first user is permitted to see bets placed by other users in the group within the first user's interface. Also, the first user may be permitted to interact with personal bet information within the display (e.g., at block 207). For instance, the first user may be permitted to send bet information associated with one of the first user's own bats to other users. In a similar fashion, the first user may interact with bets displayed for other users and perform certain actions such as tailing another user's bet, commenting about it, forwarding it to other users, among other actions. At block 208, the process 200 ends.

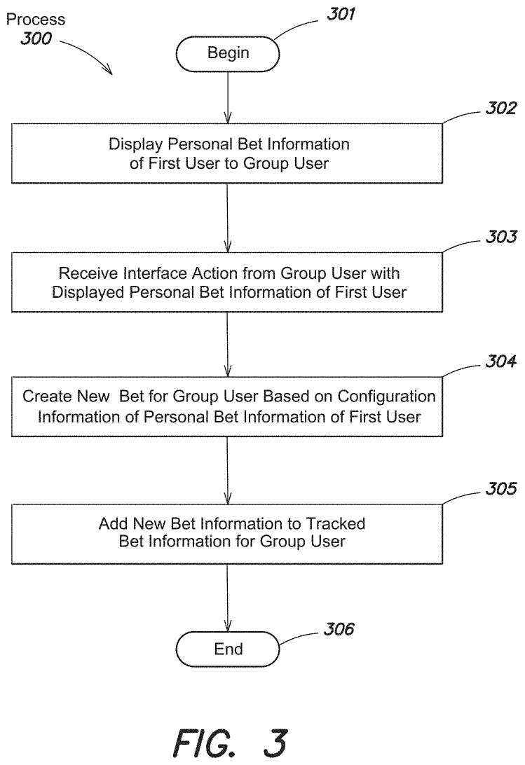

FIG. 3 shows an example process 300 for creating a new bet for a group user based on communicated bet information of a first user. At block 301, process 300 begins. At block 302, the system displays personal bet information of a first user to one or more group users. For instance, this may be done in a second user's mobile application wherein the second user adds the first user as a member of a group of users permitted to see each other's betting information. At block 303, the system receives an interface action from a group user with the displayed personal bet information of the first user. For instance, a group user may be permitted to tail the first user's bet that was displayed to the group user. At block 304, the system creates a new bet for the group user based on the configuration information of the personal bet information of the first user. As discussed, in some embodiments, the system is capable of performing underlying actions to create a new bet based on an existing user bet (e.g., of the first user). This may be accomplished, for example, by using deep linking and integration with a sports betting system (e.g., a FanDuel system). Once created, at block 305, the system may add new bet information to any existing bet information for the group user (e.g., for tracking). The system may then present (either in a consolidated bet interface or detailed view) the new bet information. At block 306, process 300 ends.

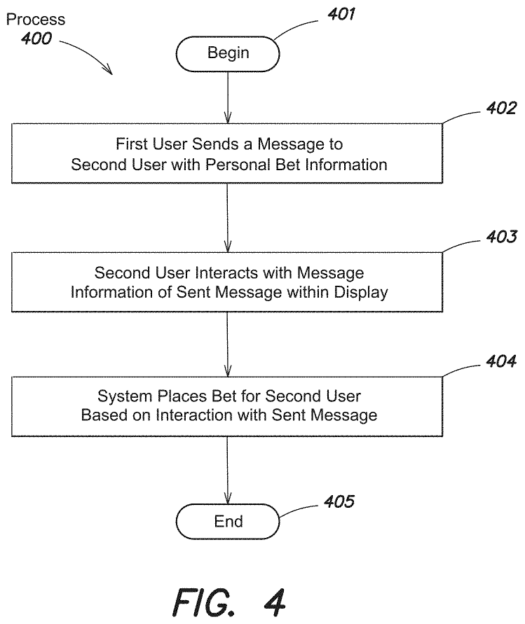

FIG. 4 shows an example process 400 for messaging bet information between users. At block 401, process 400 begins. At block 402, the first user sends a message to a second user with personal bet information. For example, within a “chat-like” interface with a message line in a chat conversation with a second user, the user may send a second user (or even a group of users in a chat session) personal bet information. This may be accomplished for example by right-clicking a representation of a bet and executing a “send” command that forwards the bet to another user. The second user may also be permitted to interact with the message information within the sent message within the display (e.g., at block 403).

For instance, the second user may be permitted to duplicate the bet (e.g., by clicking on it and performing an action), commenting on it, associating emojis with the bet, liking it, hating it, or performing other action. In this way, the number of user actions is reduced to better communicate better information between users and to perform other social networking operations on the information. As discussed, one of the operations that the second user can perform is copying or “tailing” the bet placed by the first user. At block 404, based on a second user's interaction with the bet information within the message application, the system places a bet for the second user based on the interaction with the sent message from the first user. At block 405, process 400 ends.

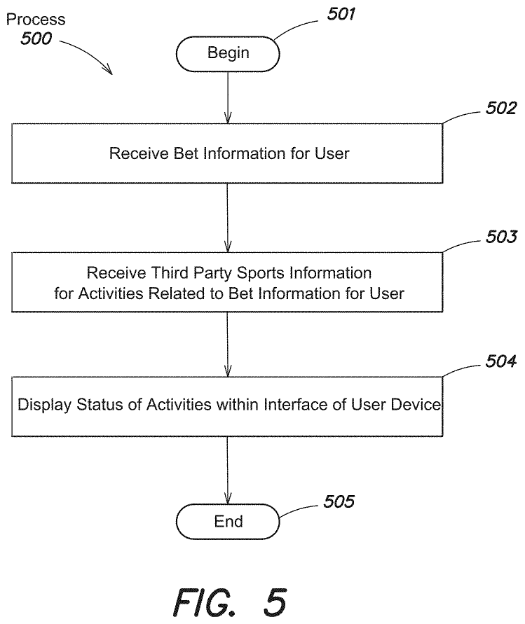

FIG. 5 shows an example process 500 for receiving third party sports information for activities related to bet information for user. As discussed above, the system may receive real time sports information related to the events upon which bets are placed. To this end, the system may be integrated with one or more third party sports information systems to accomplish this (e.g., ESPN, CBSSports, or other systems). In some implementations, Application Programming Interfaces (APIs) may be used to perform integrations with sportsbooks and/or third-party sports data services (e.g., as provided commercially by Sportradar US, New York, N.Y.). At block 501, process 500 begins. At block 502 the system receives bet information for a user. As discussed, this may relate to a sports event such as a game. At block 503 the system may receive third party sports information for activities relating to the bet information for the user. For example, if the bet relates to a sporting event, real-time information may be received regarding that sporting event. At block 504, the system displays a status of activities within the interface of the user's device. So, in some implementations, the user is permitted to see real-time scoring information relating to all of the games upon which that user has bet (or in some implementations, all the games in which his group of friends have bet). At block 505, process 500 ends.

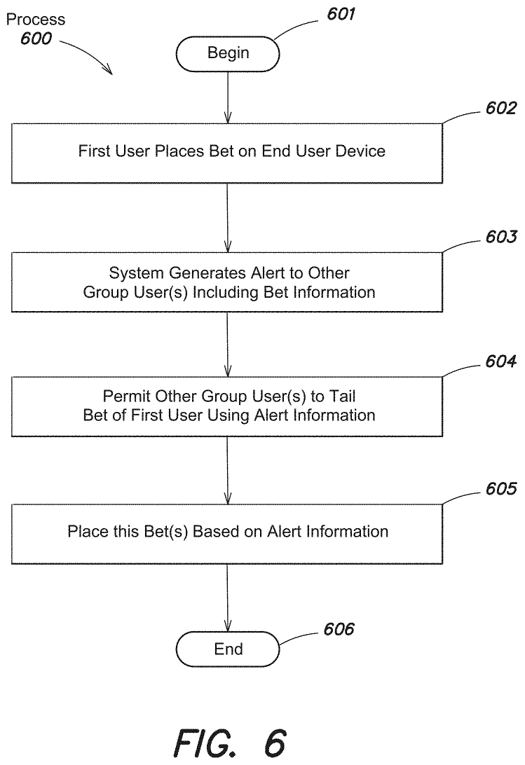

FIG. 6 shows an example process 600 for tailing a bet of another user. As discussed above, one of the functions that may be provided by the system is the ability to easily tail another user's bets that are placed within the system. For example, if group communication is provided, bet information for one user may be displayed to other users within a group. In another implementation, there may be professional bettors or experts whose bet information may be displayed to other users (e.g., as part of a subscription or other functionality). At block 601, process 600 begins. At block 602, a first user places a bet on an end user device (e.g., a mobile device and messaging application is described above). At block 603, the system generates an alert to other group users including the bet information just placed by the first user. For example, the bet information may appear as an alert, within a banner, or within a text conversation (or combination thereof).

At block 604, the system permits one or more other group users to tail the placed bet of the first user based on the information displayed within the interface (e.g., an alert, a banner, a list or other visual indicator). At block 605, the system places this bet based on the information displayed within the interface (e.g., alert information). The alert information may include, for example, information identifying parameters associated with the bet, any systems upon which the bet may be placed, or other identifying information. In some embodiments, the system may include any necessary information for placing the bet on a particular sports betting system. At block 606, the process ends.

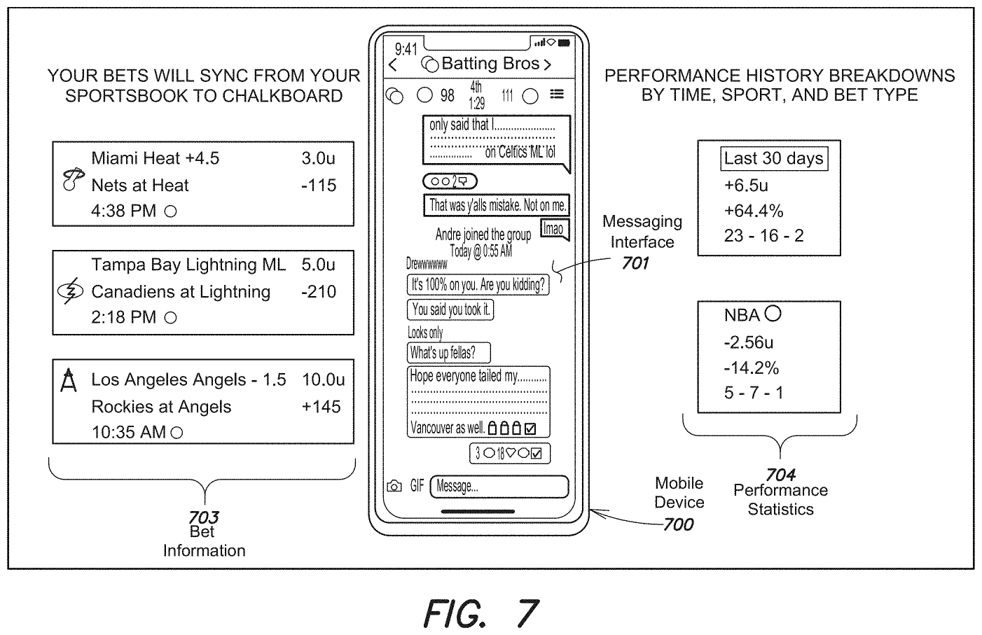

FIG. 7 shows an example interface for a messaging application that is configured to communicate bet information. For example, as discussed above, the system may include an application that executes on end system such as a mobile device (e.g., mobile device 700). Mobile device 700 executes an application program that displays a messaging interface (e.g., messaging interface 701) that includes icons, controls, a message line, and other interface features typically found in a messaging application. In some embodiments, the system and application permit the user through the interface to send and/or otherwise communicate bet information (e.g., bet information 703) to one or more other users. Such information may be communicated within the message itself, a banner, a list or other visual feature provided by the messaging interface 701. Further, the system may be capable of generating performance statistics 704 for a particular user based on their betting activity with one or more third-party sports book systems.

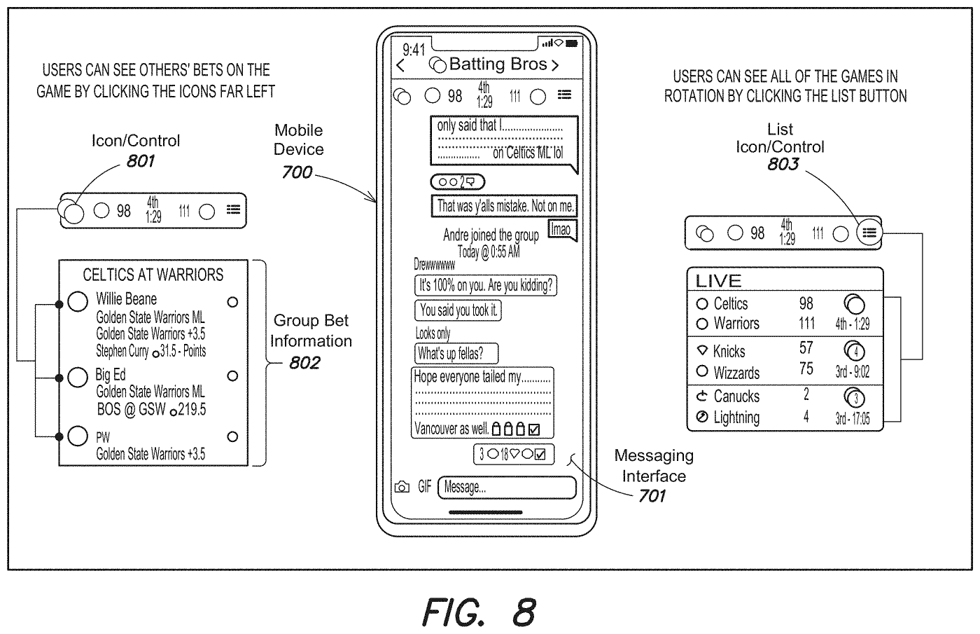

FIGS. 8 through 23 show various alternative interfaces for communicating bet information among users within a messaging application. In particular, FIG. 8 shows information related to other user's bets within the interface for instance, messaging interface 701 may include a banner section which includes an icon or other type of control 801, that when selected, shows group bet information for users of a particular group in relation to a particular game. So, for instance, for the game Celtics at Warriors, selection of control 801 will cause the interface to display group bet information 802 for three users. In another portion of interface 701, the system may provide a list icon/control 803 that permits the user to see all of the games/events that are displayed within a rotation of a banner. As discussed above, in some embodiments, a banner, carousel or other visual element is provided that shows all of the events in which the group members are betting. When new bets are placed, the information is updated to all users substantially in real-time. By activating the list icon/control 803, the user is permitted to see all of the live events occurring within a list format.

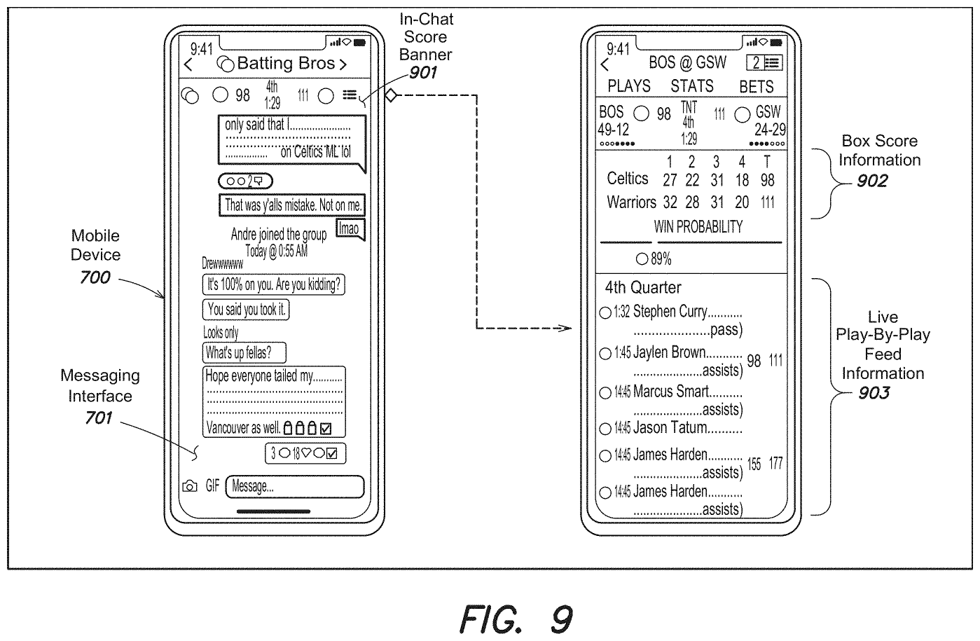

FIG. 9 shows another embodiment of an interface in which more specific information can be obtained regarding a particular event. According to some embodiments of a messaging interface 701, the interface includes an in-chat score banner 901 that displays in a rotating fashion information relating to the particular events in which group users have placed bets. Upon selecting a control for a particular game within that banner, a user may expand it to display more specific information relating to the event such as box score information 902, live play-by-play feed information 903, or any other statistics or detailed information relating to that particular event. Such information may be obtained, for example, through one or more third-party systems such as ESPN, CBSSports, Sportradar, or other third-party provider. Notably, information associated with particular events upon which bets are placed is provided within a single interface and reduces the number of user steps needed to access such information.

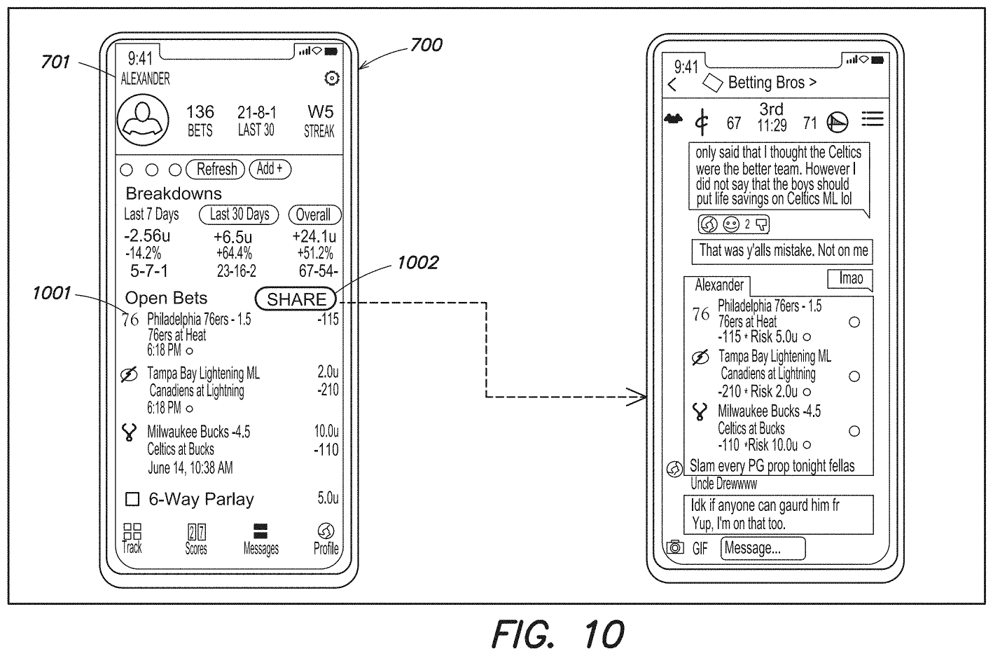

FIG. 10 shows additional information that may be shared among the users in a group on a user's messaging interface on a mobile device 700. In one embodiment of a messaging interface 701, a list of one or more of a user's open and/or closed bets 1001 along with a “share” button 1002 may be displayed. If the user were to select the “share” button 1002, that user's open and/or closed bets 1001 may be sent to and displayed on one or more other users' messaging interface 701 on those users' mobile devices 700.

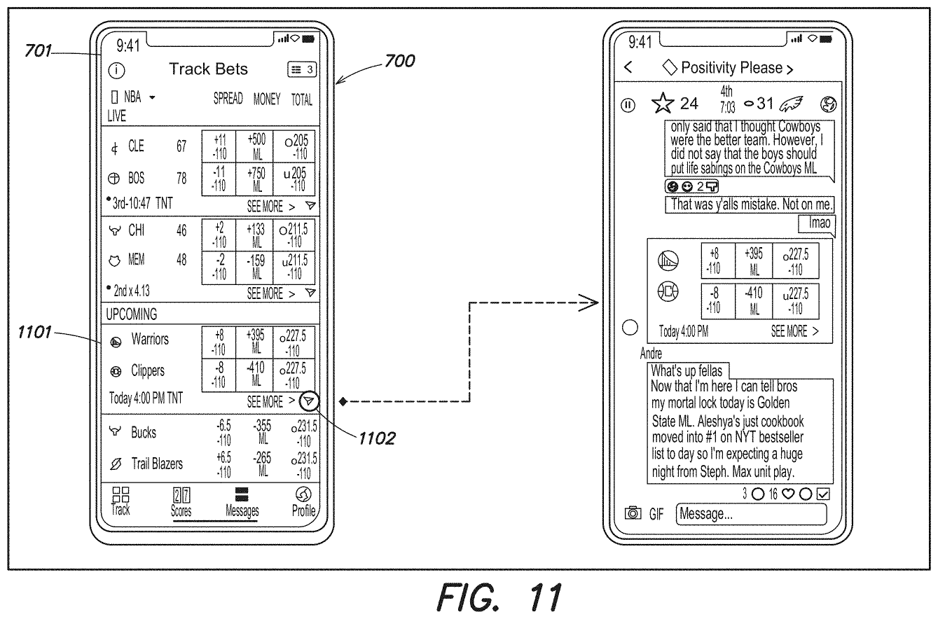

FIG. 11 shows additional information that may be shared among the users in a group on a user's messaging interface 701 on a mobile device 700. In one embodiment of a messaging interface 701, information such as a spread, amount of money bet on a team, total, etc. 1101 about a particular game such as a basketball game may be displayed along with a “send” button 1102. In one embodiment, the “send” button 1102 is a symbol resembling a paper airplane. If the user were to select the “send” button 1102, the information for the selected game 1102 may be sent to and displayed on one or more other's users' messaging interface 701 on those users' mobile devices 700.

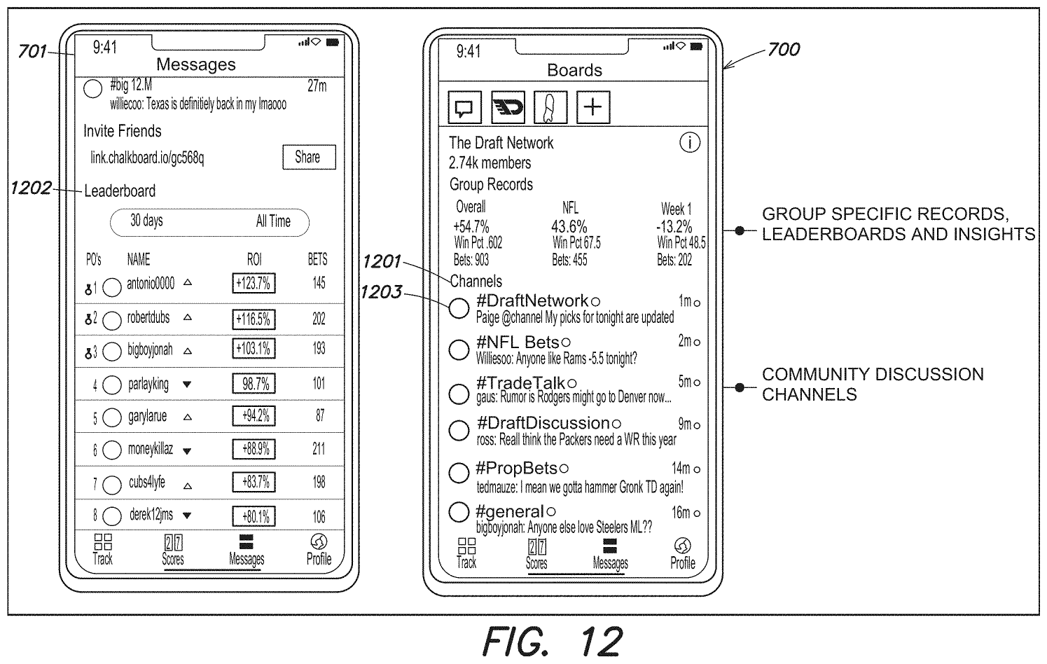

In one embodiment of the present invention, users may join one or more community discussion channels. FIG. 12 shows information that may be displayed on a user's messaging interface 701 on a mobile device 700 about these community discussion channels. In one embodiment of a messaging interface 701, a list of community discussion channels 1201 may be displayed. In another embodiment of a messaging interface 701, information about a particular discussion channel (e.g., the Draft Network) 1203 such as the number of members may be displayed. In another embodiment a leaderboard 1202 for a group of users may be displayed. In another embodiment of a messaging interface 701, the leaderboard my include the name, return on investment (ROI), and number of bets for one or more users listed on the leaderboard 1202.

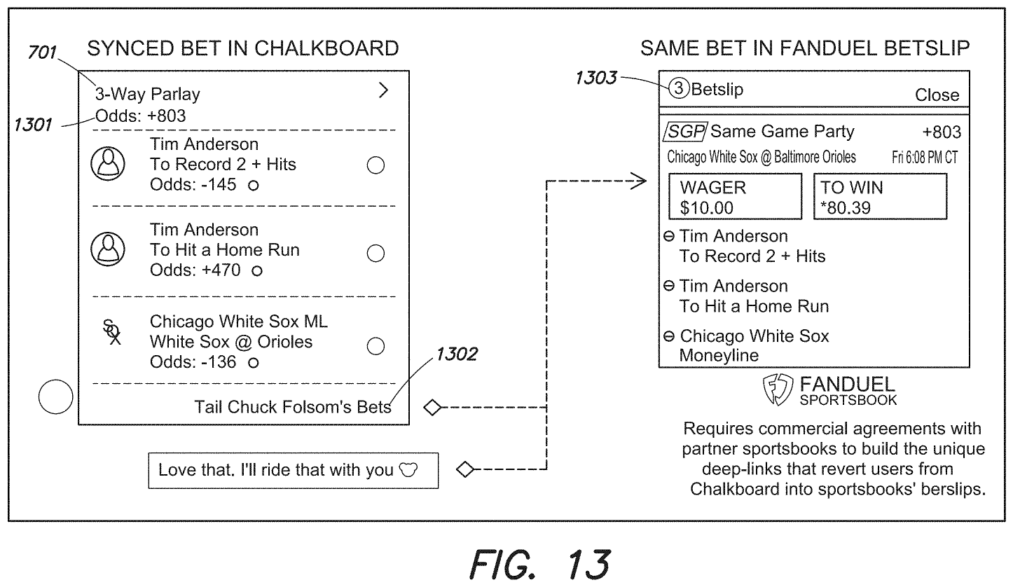

In one embodiment of the present invention, users may display at least one synchronized bet (“synced bet”), a combination of a bets (“parlay”), etc. from another user in a group. In one embodiment, a user may “tail” or duplicate one or more bets (e.g., an individual bet, a synced bet, a parlay) made by another user, as shown in FIG. 13. In one embodiment of a messaging interface 701 on a mobile device 700 for a user, information such as a synced bet, a parlay, etc. 1301 made by another user in a group may be displayed along with a “tail” button 1302. In one embodiment, the “tail” button 1302 includes an identifier such as a name for the user making the bet (e.g., individual bet, synced bet, a parlay). If the user were to select the “tail” button 1302, the information about the bets made by the user identified in the “tail” button 1302 may be displayed on the user's messaging interface 701 on the user's mobile device 700. In one embodiment, for example, the information about the bets made by the user may include a bet slip 1303 in a third party's sportsbook such as Fanduel may be displayed on the user's messaging interface 701. The information about the bet slip 1303 may include an identifier of an athletic competition such as a baseball game, the amount of the wager, the amount of money the user will make from the bet, information about a synced bet or parlay such as the name of a team on which the user has bet, the name of a player on which the user has bet, the achievements of the player on which the user has bet (e.g., number of home runs, number of hits).

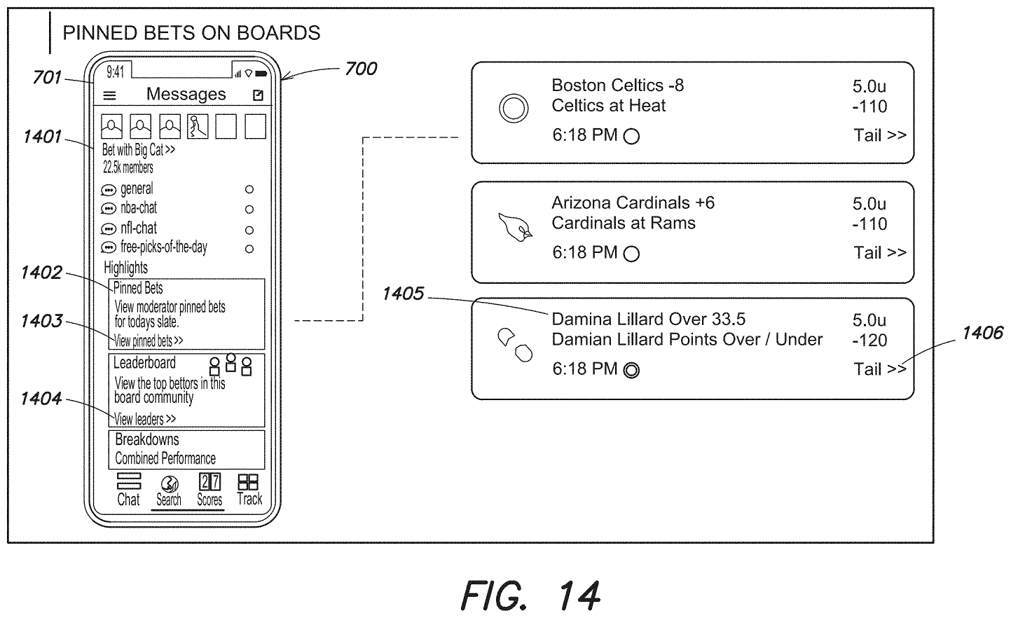

In one embodiment of the present invention, a user may pin the user's bets on a board. FIG. 14 shows information that may be displayed on a user's board 1401 on a messaging interface 701 on a mobile device 700. In one embodiment of a messaging interface 701, pinned bets 1402 along with a “View Pinned Bets” button 1403, a Leaderboard along with a “View Leaders” button 1404, Breakdowns, etc. may be displayed. If a user were to select the “View Pinned Bets” button 1403 for the user that pinned bets on the board, information 1405 about the pinned bets 1402 such as the teams participating in the game (e.g., Boston Celtics and Miami Heat), odds data such as a spread, and a “tail” button 1406 may be displayed on a messaging interface 701 on the mobile device 700 of the user selecting the “View Pinned Bets” button 1404. If the user were to then select the “tail” button 1406, the information about the bets made by the user identified in the “tail” button 1406 may be displayed on the user's messaging interface 701 on the user's mobile device 700. In one embodiment, for example, the information about the bets made by the user may include a bet slip 1303 in a third party's sportsbook such as Fanduel as shown in FIG. 13 may be displayed on the user's messaging interface 701.

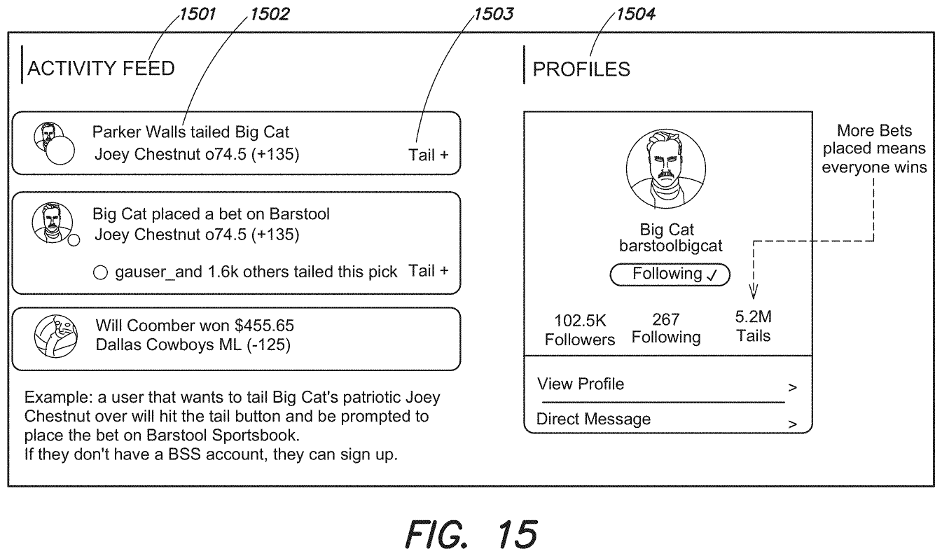

In one embodiment of the present invention, activity feeds 1501 and/or profiles 1504 for users such as celebrities and/or well-known gamblers may appear on a message board on a messaging interface 701 on a mobile device 700, as shown in FIG. 15. In one embodiment of a messaging interface 701, messages such as one user tailing a bet of another user 1502 along with a “tail” button 1503, another user's bet along with a “tail” button, etc. may be displayed on a messaging interface 701 on a user's mobile device 700. If the user were to select the “tail” button 1503, the information about the bet identified in the “tail” button 1503 may be displayed on the user's messaging interface 701 on the user's mobile device 700. In one embodiment, for example, the information about the selected bet may include a bet slip 1303 in a third party's sportsbook such as Fanduel as shown in FIG. 13 may be displayed on the user's messaging interface 701. In one embodiment, the displayed profile 1504 of a user may include an identifier for the user, the number of followers, the number of tails made by other users, etc.

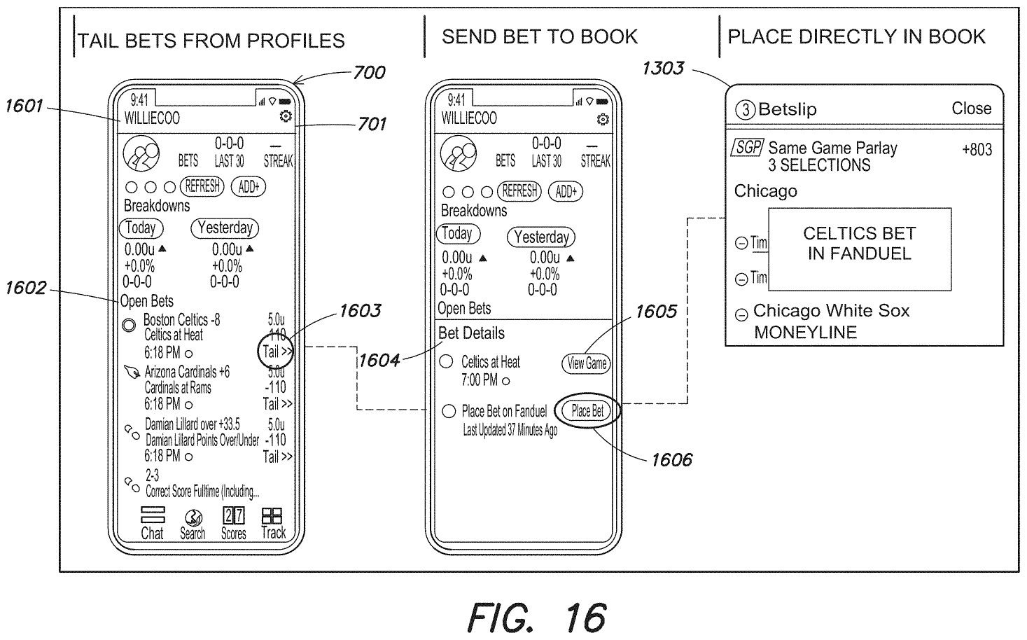

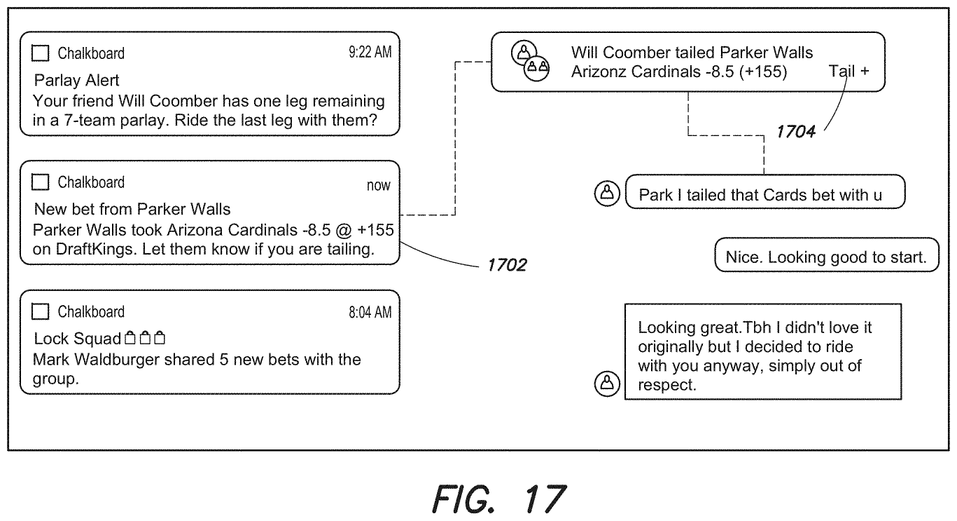

In one embodiment of the present invention, users can visit profiles of their friends and easily tail bets that are made by their friends and are synced from a partner's sportsbook. FIG. 16 illustrates one such exemplary user profile 1601 displayed on a messaging interface 701 on a user's mobile device 700. In one embodiment of a messaging interface 701, a user's profile 1601 may include a Breakdown summary, a list of open bets 1602 along with “tail” buttons 1603. If a user were to select a “tail” button 1603, the information about the bet 1604 identified in the “tail” button 1603 may be displayed on the user's messaging interface 701 on the user's mobile device 700. In one embodiment, for example, the information about the bet may include the names of the teams participating in a game along with a “View Game” button 1605, the name of the third-party sportsbook on which the bet was place (e.g., Fanduel) along with a “Place Bet” button 1606. If a user were to select the “Place Bet” button 1606, additional information about the bet including a bet slip 1303 such as the one illustrated in FIG. 13 or the one illustrated in FIG. 16 may be displayed on the user's messaging interface. In another embodiment of the present invention, users may receive messages about bets 1702 made by other users and have the option to instantly tail 1704 them as illustrated by FIG. 17.

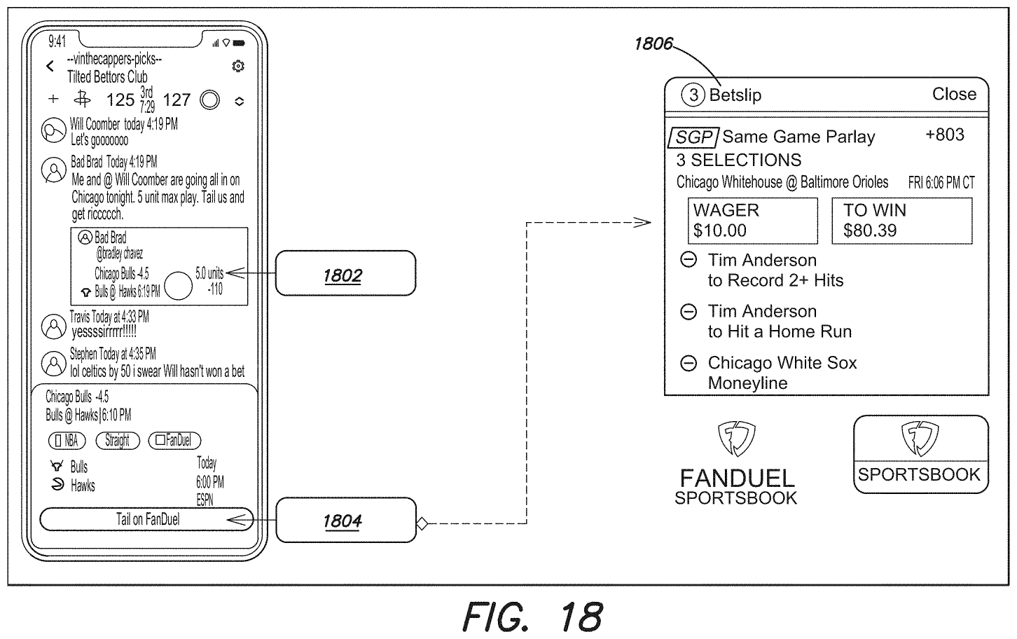

In one embodiment of the present invention, bets that are synced with a partner's sportsbook such as FanDuel sportsbook, DraftKings Sportsbook, Caesars Sportsbook, etc. may be deep-linked into the particular sportsbook where a bet was placed. In another embodiment, a bet for one user may be pre-populated with data from another user's bet or suggested bet. FIG. 18 illustrates the steps that may be performed for one user to “tail” a bet suggested or made by another user in one embodiment of the invention. In step 1802, a user clicks on a message from another user identifying a bet suggested or made by the other user. In step 1804, after information about that bet including a “tail” button is displayed on a messaging interface 701 of a user's mobile device 700, the user may select the “tail” button. In step 1806, a bet slip in the partner sportsbook's web site is displayed.

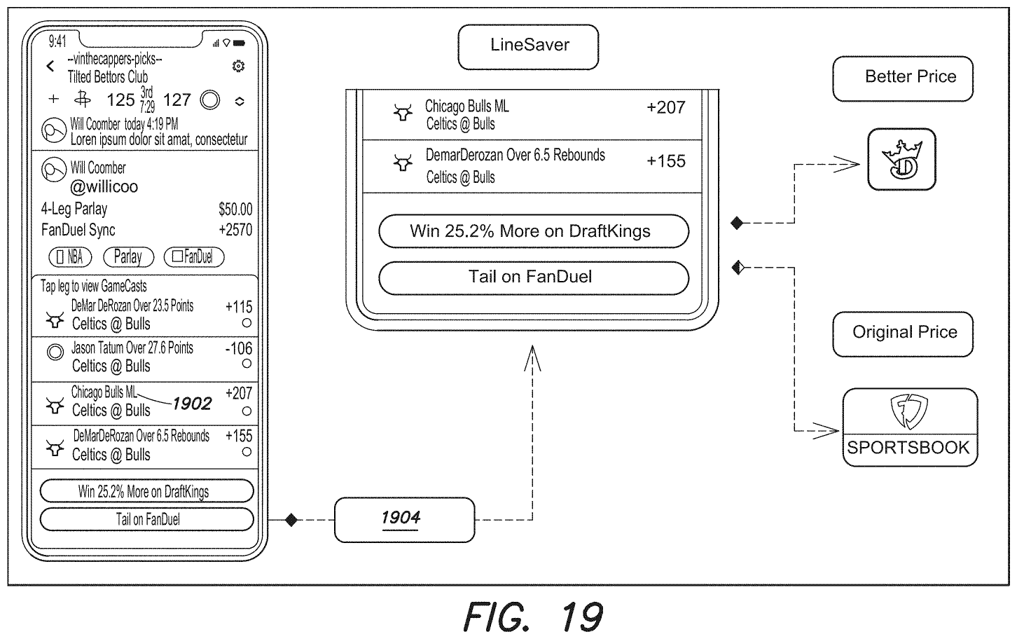

In one embodiment of the present invention, a user is given a choice of two or more sportsbook partners from which to make a bet that is tailed from another user. FIG. 19 illustrates the steps that may be performed for a first user to “tail’ a bet made by a second user and to have the option of selecting a sportsbook partner to make the bet, rather than being forced to make the bet at the same sportsbook partner where the second user previously made the bet. In step 1902, a first user clicks on a message from a second user identifying a bet made by the second user, as the user did in FIG. 18. In step 1904, the first user is given an option of two or more sportsbook partners from which to make the same bet as the second user and selects one of the options. In the example shown in FIG. 19, the first user may choose to make the bet from either DraftKings or FanDuel, where the second user placed the bet. That is, the first user need not make the bet from the same sportsbook partner that made the bet for the second user. In the next step, a bet slip in the selected partner sportsbook's web site is displayed.

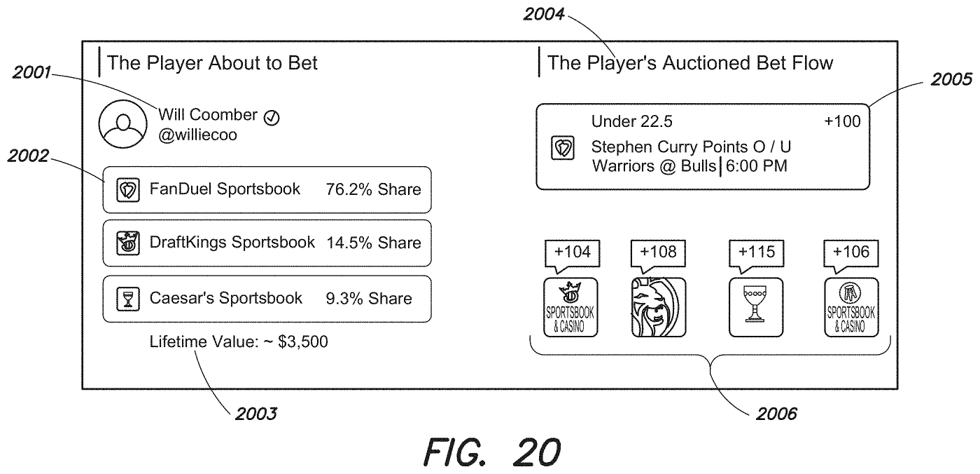

In one embodiment of the present invention, different sportsbook partners bid for bets from users in a bet auction platform. FIG. 20 illustrates an exemplary bet auction platform. In one embodiment, a profile for a player 2001 who is about to place a bet is displayed. In one embodiment, the displayed profile includes share percentages 2002 for one or more sportsbook partners such as FanDuel Sportsbook, DraftKings Sportsbook and Caesars Sportsbook and/or a lifetime value 2003 for the user of the displayed profile. In one embodiment, a user's auctioned bet flow 2004 is displayed. In one embodiment, the display user's auctioned bet flow includes a possible bet 2005 and one or more sets of terms 2006 offered by one or more sportsbook partners respectively.

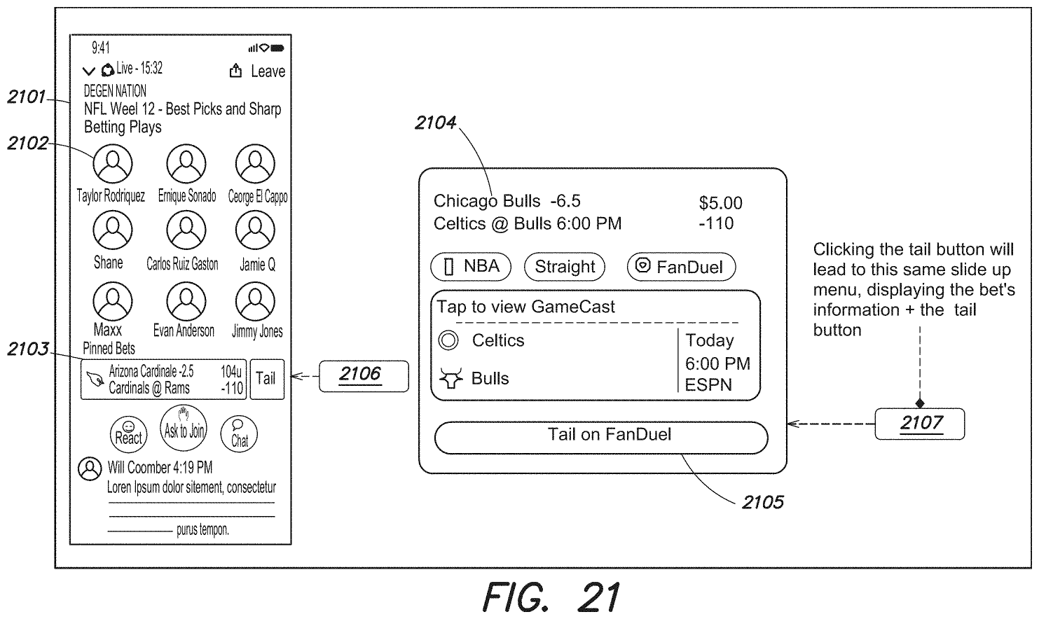

One embodiment of the present invention includes live audio rooms in which users in a group may speak to one another, as illustrated in FIG. 21. In one embodiment, the display of a live audio room 2101 on a user's messaging interface 701 on a user's mobile device 700 includes images of the users 2102 who are present in the live audio rooms and/or one or more bets 2103 that may be pinned by the users present in the live audio room. FIG. 21 illustrates the steps that may be performed by a user who is present in the live audio room to tail a bet that has been pinned in the display of the live audio room 2101. In step 2106, a user present in the live audio room selects a “tail” button adjacent to one of the pinned bets 2103 shown on the live audio room display 2101. After the user selects one of the pinned bets, information on the selected bet 2104 may be displayed. The information may include the names of the teams in the sporting event for the selected pinned bet, the terms of the bet, the names of one or more sportsbook partners offering the bet, and a “tail button” 2105 for each sportsbook partner offering the bet. In step 2107, the user may opt to make the displayed bet by clicking on the “tail” button. If the user clicks the “tail” button in step 2107, a bet slip 1302 like the shown in FIG. 13 is displayed. In one embodiment, a bet slip in the selected partner sportsbook's web site is displayed.

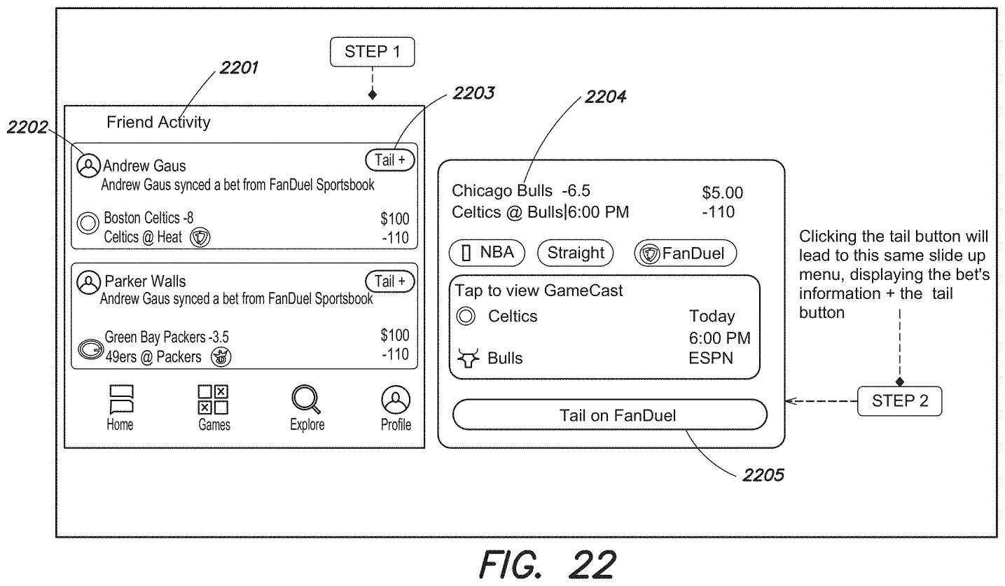

One embodiment of the present invention includes a feed of the suggested and/or made bets by one or more friends of a user, as illustrated in FIG. 22. In one embodiment, the display of the friends bets feed 2201 on a user's messaging interface 701 on a user's mobile device 700 includes images of the friends 2202 who suggest or make bets and/or the suggested and/or made bets 2203 by the friends. FIG. 22 illustrates the steps that may be performed by a user who desires to tail a bet that is shown on the friends bets feed 2201. In step 1, a user present in the live audio room selects a “tail” button adjacent to one of the bets 2203 shown on the friends bets feed 2201. After the user selects one of the bets, information on the selected bet 2204 may be displayed. The information may include the names of the teams in the sporting event for the selected pinned bet, the terms of the bet, the names of one or more sportsbook partners offering the bet, and a “tail button” 2205 for each sportsbook partner offering the bet. In step 2, the user may opt to make the displayed bet by clicking on the “tail” button. If the user clicks the “tail” button in step 2, a bet slip 1302 like the shown in FIG. 13 is displayed. In one embodiment, a bet slip in the selected partner sportsbook's web site is displayed.

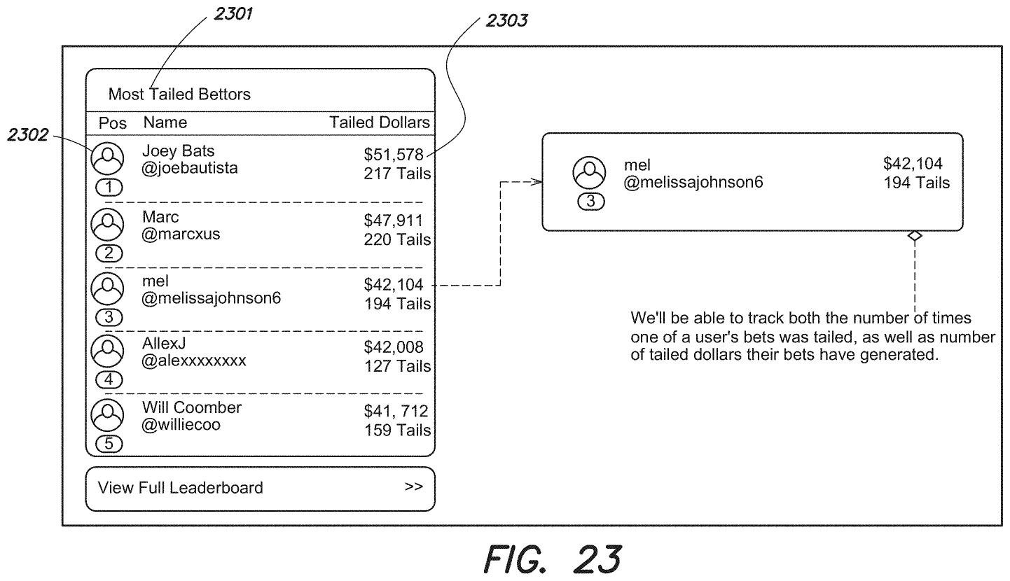

One embodiment of the present invention includes a leaderboard showing the betters who are the most tailed, as illustrated by FIG. 23. In one embodiment the display of the tailed leaderboard 2301 on a user's messaging interface 701 of a user's mobile device 700 includes images of the users 2302 who are tailed the most, the number of tailed bets 2302 for each of the displayed users and the amount of money tailed 2302 for each of the displayed users.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system for collaboration among a plurality of users comprising:
a messaging interface comprising a plurality of display elements, at least one of the plurality of display elements configured to:
display bet information of a first user of the plurality of users to a second user of the plurality of users including identifying information of a bet that was made or suggested by the first user; and
display a control permitting the second user to select to tail the bet that was made or suggested by the first user.

2. The system according to claim 1, wherein the at least one of the plurality of display elements is configured to display bet information relating to members of a group to which the first user belongs.

3. The system according to claim 1, further comprising an interface configured to receive bet information for the first user from one or more third party sources.

4. The system according to claim 3, further comprising means for storing a profile for the first user and means for requesting the bet information for the first user from the one or more third party sources and means for associating the bet information with the profile.

5. The system according to claim 1, wherein the messaging interface is adapted to send, from the first user, bet information relating to a third party betting platform to a second user.

6. The system according to claim 3, wherein the at least one of the plurality of display elements is configured to display, within a banner section of the messaging interface, the received bet information for the first user from the one or more third party sources.

7. The system according to claim 1, wherein the messaging interface includes at least one of a group comprising Facebook messenger, WhatsApp, Kik, WeChat, Twitter, or any person-to-person or person-group messaging interface.

8. The system according to claim 1, wherein the messaging interface is configured to permit the first user to view bet information of a second user, and wherein the messaging interface includes a control that permits the first user to perform a tail bet on a bet defined within the viewed bet information of the second user.

9. The system according to claim 3, further comprising a statistics component that is configured to analyze betting performance of the first user based on, at least in part, the received bet information for the first user from one or more third party sources.

10. The system according to claim 1, wherein the messaging interface is configured to display within at least a portion of the interface, live score information relating to the bet that was made or suggested by the first user, received from one or more third party sources.

11. The system according to claim 6, wherein the at least one of the plurality of display elements is configured to display, within a banner section of the messaging interface, bet information relating to members of a group to which the first user belongs.

12. The system according to claim 5, wherein the messaging interface is adapted to send, from the first user, bet information relating to members of a group to which the first user belongs.

13. The system according to claim 1, wherein the messaging interface is configured to display within at least a portion of the interface, a leaderboard listing one or more of the plurality of users having the best betting performance.

14. The system according to claim 13, wherein the messaging interface is configured to display on the leaderboard betting records for the one or more users having the best betting performance including return on investment over one or more time periods.

15. The system according to claim 1 wherein the messaging interface is configured to display a bet auction in which at least one of a plurality of sportsbooks makes one or more bids to place the bet selected by the second user, the one or more bids including odds for the selected bet.

16. The system according to claim 1 wherein the messaging interface is configured to display within at least a portion of the interface a leaderboard listing one or more of the plurality of users having the most tailed bets.

17. The system according to claim 16 wherein the messaging interface is configured to display on the leaderboard betting information for the one or more users having the most tailed bets including the number of tailed bets, and the dollar amount of the tailed bets.

18. A method for collaborating with a plurality of users comprising the steps of:
receiving and displaying bet information of a first user of the plurality of users on a device for a second user of the plurality of users, the bet information including identifying information of a bet that was made or suggested by the first user;
displaying a control on the device of the second user, the control permitting the second user to select to tail the bet that was made or suggested by the first user; and
selecting the control on the device of the second user for the second user to tail the bet that was made or suggested by the first user.

19. A method for collaborating with a plurality of users according to claim 18 further comprising the step of receiving and displaying on the device of the second user a leaderboard listing one or more of the more of the plurality of users having the best betting performance.

20. A method for collaborating with a plurality of users according to claim 19 further comprising the step of receiving and displaying on the device of the second user betting records for the one or more users listed on the leaderboard, the betting records including return on investment over one or more periods of time.

21. A method for collaborating with a plurality of users according to claim 18 further comprising the step of receiving and displaying on the device of the second user one or more bids from corresponding one or more sportsbooks to place the bet that was selected by the second user, the one or more bids including odds for the selected bet.

22. A method for collaborating with a plurality of users according to claim 18 further comprising the step of receiving and displaying on the device of the second user a leaderboard listing one or more of the plurality of users having the most tailed bets.

23. A method for collaborating with a plurality of users according to claim 22 further comprising the step of receiving and displaying on the device of the second user betting records for the one or more users listed on the leaderboard, the betting records including the number of tailed bets, and the dollar amount of the tailed bets.

24. A non-transitory computer-readable media comprising instructions that, when executed by one or more processors on a computing device, are operable to cause the one or more processors to execute the method of claim 18.
